(19) United States
(12) Patent Application Publication
(10) Pub. No.: US 2009/0325223 A1
(43) Pub. Date: Dec. 31, 2009

(54) MAGNETIC IMMUNOHISTOCHEMICAL STAINING DEVICE AND METHODS OF USE

(76) Inventor: TIMOTHY BOYD, Seffner, FL (US)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/490,921

(22) Filed: Jun. 24, 2009

Related U.S. Application Data
(60) Provisional application No. 61/132,945, filed on Jun. 24, 2008.

(51) Int. Cl. G01N 1/30; G01N 1/31

(52) U.S. Cl. 435/40.5; 435/283.1

(57) ABSTRACT

The subject invention concerns a device for use in staining samples or tissues of interests on slides. The subject invention also concerns methods of using the device to stain a specimen on a slide or to detect antibody and proteins of interest of a tissue section.

### CROSS-REFERENCE TO RELATED APPLICATION

The present application claims the benefit of U.S. Provisional Application Ser. No. 61/132,945, filed Jun. 24, 2008, which is hereby incorporated by reference herein in its entirety, including any figures, tables, nucleic acid sequences, amino acid sequences, and drawings.

### BACKGROUND OF THE INVENTION

Immunohistochemistry (IHC) is an immunology-based technique that allows for the localization and presence of proteins within tissue sections. IHC protocols involve rehydrating slide-mounted tissue sections, washing and blocking unintended binding sites, and administering an antibody solution, under gentle agitation and time and temperature constraints, which allow the antibody to bind to specific target proteins within the tissue. Microscopy is later used to analyze the antibody-stained tissue sections.

There are several methods for preparing and sectioning tissues so that they can be mounted upon slides. One method consists of sectioning fixed, frozen tissue and placing the cut sections into an aqueous solution. When preparing the slides that these tissue sections will be mounted upon, a barrier, such as rubber cement, wax pen, or the commercially-available IMMEDGEPEN, will be placed around the specimen area to later help hold the antibody solution on the slide and prevent it from running off during the antibody-binding and agitation steps of IHC. Without this barrier, solution will leak out from around the tissue section and the tissue section can dry out. Frozen sectioning is not always an optimal choice for researchers, since the tissue can distort while it is being cut, and since the sections are difficult to mount on slides when they are less than 15 microns thick. Paraffin embedding, on the other hand, allows the tissue to be sectioned and mounted on slides at thicknesses of 3-5 microns. This allows for increased tissue analysis and a decrease in non-specific background staining. However, the microscope slides cannot have a barrier prepared in advance, due to the steps involved in deparaffinization, optional antigen retrieval, and followed immediately by IHC. FIG. 1 shows a standard deparaffinization protocol, written by ABCAM (a common antibody supplier), which also notes reasons why the tissue cannot dry out. When performing IHC after deparaffinization, the whole slide must be submerged in an antibody solution of usually 4-5 milliliters (illustrated in FIG. 2B). Thus, there remains a need in the art for an immunohistochemical that minimizes the amount of antibody solution needed.

### BRIEF SUMMARY OF THE INVENTION

The subject invention concerns devices for staining a slide-mounted specimen of interest, such as tissue sections, cells, and the like. A device of the invention comprises a free-standing metal bracket. In one embodiment, the invention described herein is comprised of an L-shaped or V-shaped metal bracket with a plastic block or foam mat attached on one or both sides of the bracket, wherein a slide may be mounted with a tissue section of interest. The device further comprises a magnet placed on the device wherein the magnet has an opening to allow solutions to be added onto the specimen of interest, thereby decreasing the amount of reagents necessary to stain the specimen. Multiple devices can be placed together for multiple staining applications. An advantage of the subject device over staining platforms available in the art is that less reagent or staining solution is needed to achieve the same result as a standard staining application. For example, in one embodiment, only about 300 microliters of antibody solution is necessary to stain a specimen of interest with this device, compared to at least 4 milliliters of solution in other devices in the art (FIGS. 3-5). Moreover, it can be envisioned that other types of reagents of interest can be useful with this device to stain materials on a slide.

### BRIEF DESCRIPTION OF THE DRAWINGS

FIG. 1 shows a standard paraffin removal protocol prior to a staining technique that subsequently require antibody.

FIG. 2A shows that only 300 μL of solution for each slide is needed to achieve complete coverage of the sample of interest.

FIG. 2B shows that in standard staining techniques, approximately 4 milliliters of solution is required to cover the desired area to be stained.

FIGS. 3-5 show approximately 300 microliter of solvent added to the slide with the magnets positioned on a device of the invention.

FIG. 6 shows the various elements of a device of the invention including L-shaped brackets and foam mat.

FIG. 7 shows multiple devices of the invention can be placed in close proximity without causing magnetic interference between devices, allowing multiple staining to be completed simultaneously.

FIG. 8 shows a device of the invention comprising an L-shaped metal bracket and foam mats attached to both sides of the L-shaped bracket.

FIG. 9 shows the steps of removing the slide from a device of the invention. The mats can be approximately 2-3 millimeters shorter than the L-shaped brackets to allow ease of handling the slides.

FIGS. 10A-10C show a device of the invention. FIG. 10A shows a device with a slide and a magnet thereon. FIGS. 10B and 10C show a cross-sectional representation of a slide with a magnet and detachable covering thereon.

FIG. 11 shows one example of a brand of magnet (MAGCRAFT) that can be used with a device of the invention.

FIG. 12 shows the typical size and thickness of the exemplified tissues to be stained. The thickness of the magnet can also vary depending on the size of the area to be stained and the depth of the tissues that need to be stained.

FIG. 13 shows an example of applying an outside barrier after the magnets are placed on the slide and surrounding the tissues of interest. A nonliquid/silicone barrier is obtained with an IMMEDGEPEN around the edges of the magnet.

FIG. 14 shows an outline of the solutions within the magnetic boundary and within the silocone/rubber cement barrier. This was obtained by adding a stain onto the slide platform until the stain had dried completely in order to show that the platform did not leak during the entire procedure.

FIG. 15 shows standard staining of a mouse tissue for amyloid beta using the antibody 6E10 requiring 4-5 mL of solution and antibody to detect the antigen on the tissue.

FIG. 16 shows standard staining of a mouse tissue for amyloid beta using the antibody 6E10 with a device of the invention requiring only about 300 microliter of solution and antibody to detect antigen on the tissue.

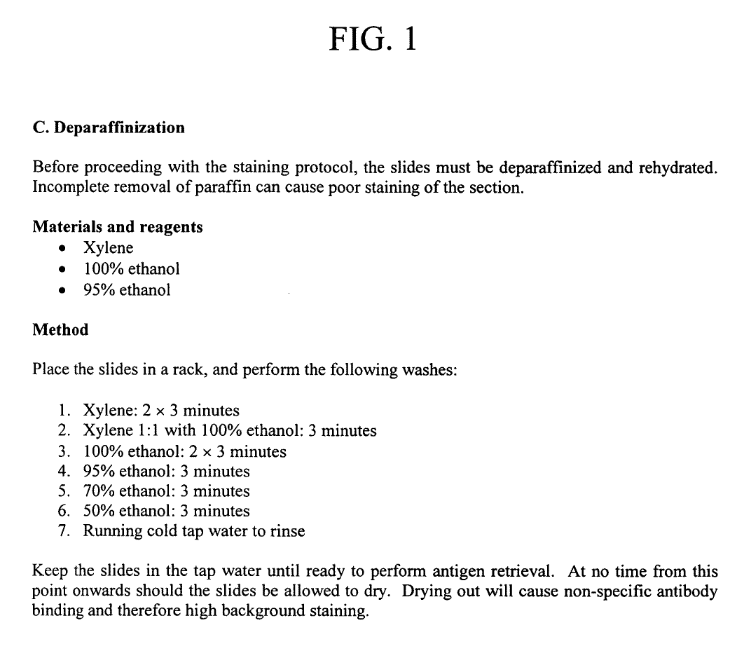

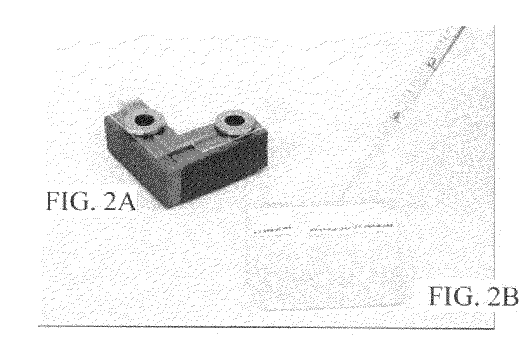

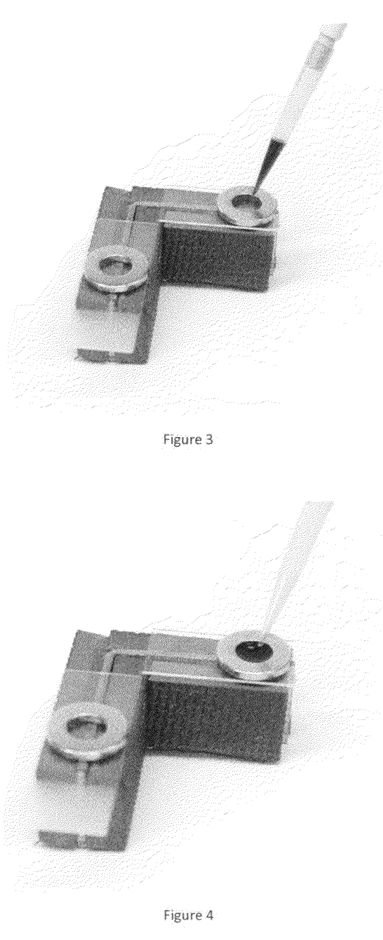

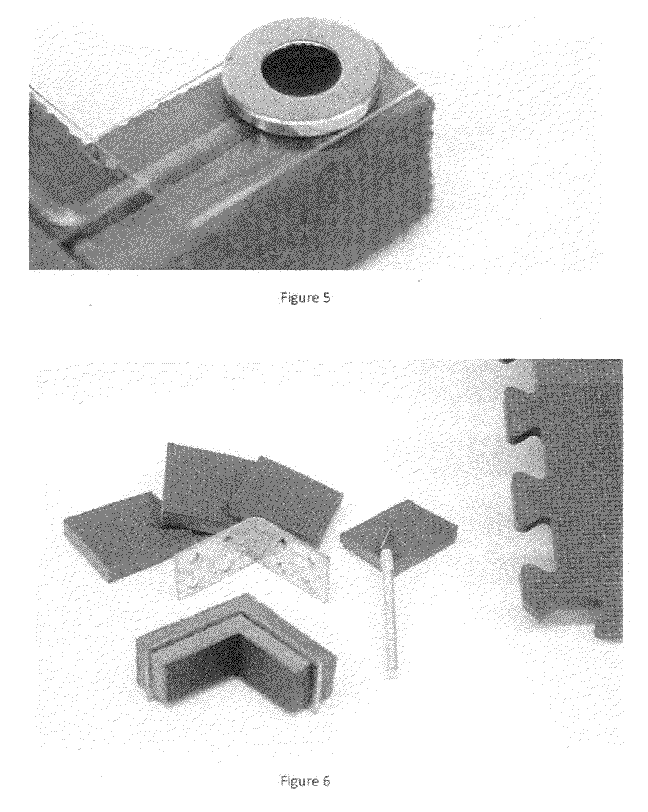

### DETAILED DESCRIPTION OF THE INVENTION

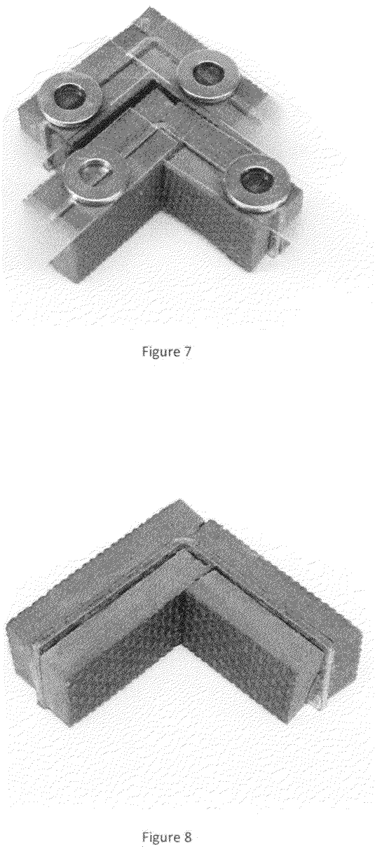

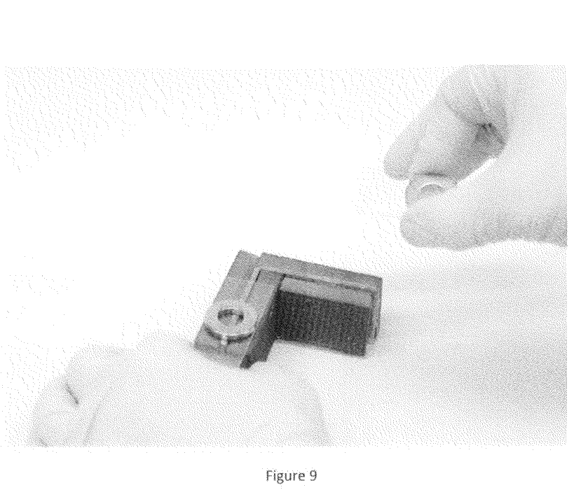

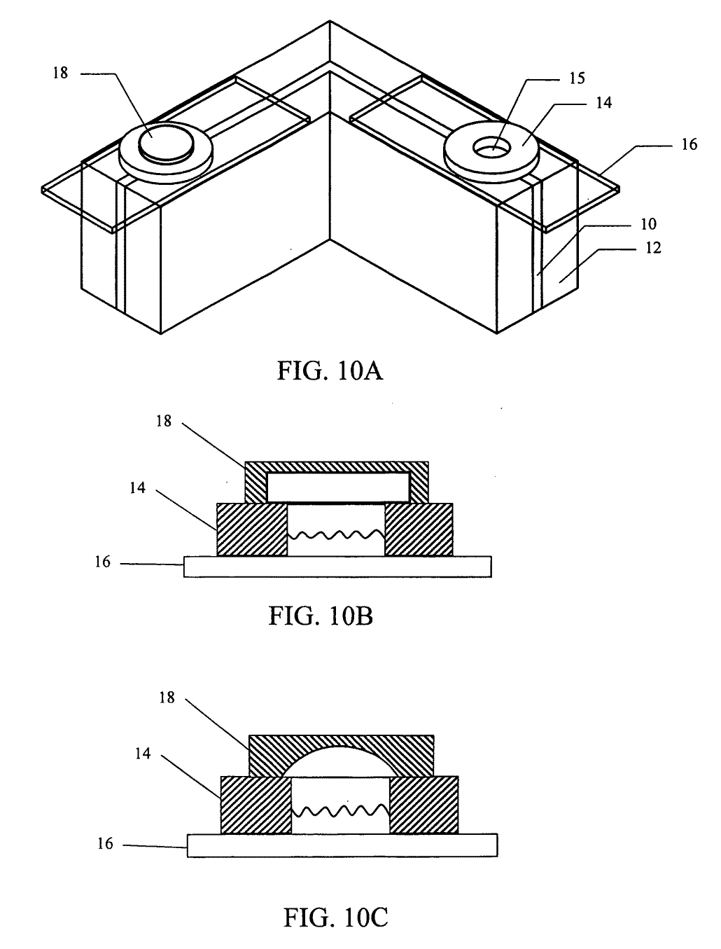

The subject invention concerns a staining device for staining a slide-mounted specimen of interest, such as tissue sections, cells and the like. A device of the invention comprises a free-standing metal bracket. A metal bracket of the device, in one embodiment, can have a general L- or V-shape, although other similar shapes are contemplated within the scope of the invention (e.g., shapes where the angle formed by the bend of the bracket is greater than or less than 90°). In one embodiment (FIG. 10A), a staining device of the invention comprises a metal L-shaped bracket (10), a plastic block or foam mat (12) (e.g., “Foam Linking Mat” (Lowes Home Improvement, Item# 168520)), and a magnet (14) having an opening (15). The plastic block or foam mat (12) can be cut and glued to the metal bracket (10) with a silicon-based adhesive (e.g., DAP Auto/Marine Sealant), but alternative adhesives would also be appropriate. The adhered plastic block or foam mats (12) on both sides of the metal brackets (10) serve to balance the device and prevent the magnets (14) from flipping over to the side during the staining procedure. The plastic block or foam mats (12) also prevent the devices from attracting each other when several devices are placed in close proximity to each other (FIG. 7). In use, a slide (16), having a tissue section, cell, etc. attached thereon, is placed on the metal bracket (10) and the magnet (14) is placed on top of the slide so that the opening of the magnet is over the specimen on the slide. In one embodiment, the plastic block or foam mat (12) does not completely cover the entire metal bracket (10) and leaves about a 1 to 4 millimeter distance from the edge of the metal bracket (10) so that the slide (16) can easily be grasped when it sits upon the metal bracket (10) (FIGS. 8-10). In one embodiment, a device of the invention can comprise a detachable covering or lid (18) that fits over the opening (15) of the magnet (14) (FIGS. 10A-10C). The covering or lid (18) can be made of metal and designed so as to minimize exposure of the specimen on the slide to light and also to reduce evaporation of reagent solution within the opening (15) of the magnet (14). Preferably, the covering or lid (18) is shaped so that the bottom of the covering or lid does not come into contact with the reagent solution within the opening (15) of the magnet (14). Thus, in one embodiment, the bottom of the covering or lid (18) is concave or not flush with the top of the magnet (14) (FIGS. 10B-10C).

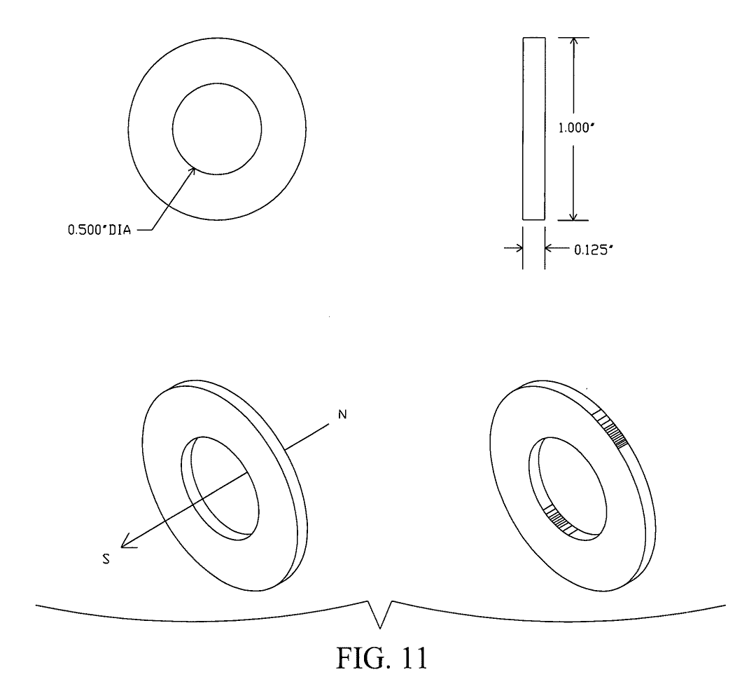

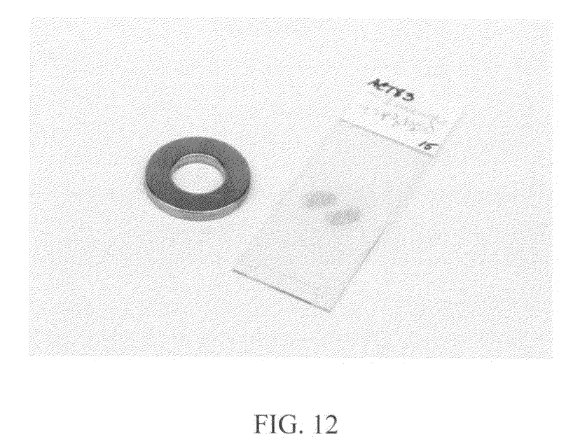

Suitable magnets are available from National Imports, a commercial magnet supplier. The magnet can be of any suitable shape and size so long as it can be placed on the slide. In one embodiment, the magnet is oral or circular in shape. In one embodiment, a circular magnet has a diameter of about 1.0″. Optionally, the magnet can be square or rectangular in shape. In one embodiment, the magnet covers just the outside edges of the slide, so that multiple tissue sections can be mounted on the slide and stained simultaneously. In one embodiment, the magnet has a width that is approximately the same as the width of the slide upon which it will be used. The magnet can also be of any suitable thickness so long as it is thick enough to retain the liquid reagent solution within the opening of the magnet when it is upon the slide. In one embodiment, the magnet is about 0.125″ thick. The opening in the magnet can be of any suitable size or shape that will permit access to the specimen on the slide when the magnet is placed thereon. The opening in the magnet should not be larger than the width of the slide that it will be placed upon; otherwise, reagent solution would be able to leak out where the opening extended past the edge of the slide. In one embodiment, a magnet of the invention has an opening with an internal diameter of about 0.5″, for example, a diameter that is large enough to encircle a coronally-sliced mouse brain (see FIGS. 11 and 12). Magnets of the invention can optionally be coated with a coating that is impenetrable or resistant to liquids, e.g., a hydrophobic polymer.

A magnet that can be used with the subject invention can be composed of any suitable magnetic material. In one embodiment, neodymium-Iron-Boron magnets are utilized as they provide the magnetic strength needed to keep most of the regent or antibody containing solution from leaking from the internal well created by the opening of the magnet on the slide. In one embodiment, a magnet will have at least about a pull force of 5.25 lb/2427 g.

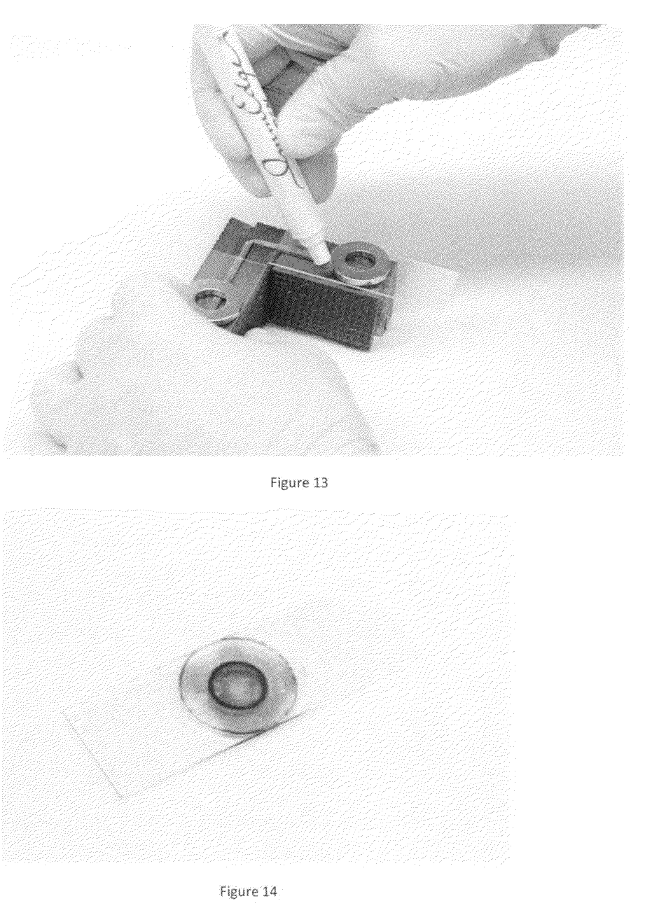

In one embodiment, a barrier that is not permeable to liquids (e.g., rubber cement, Vaseline petroleum jelly, IMMEDGEPEN reagent, etc.) can be provided around the magnet or between the bottom of the magnet and the top of the slide to prevent or eliminate solution leaking from underneath the magnet. The magnet can be placed on the slide with the opening encircling the tissue section and held together by hand. Then the slide and magnet are placed on the metal bracket. A reagent solution, such as an antibody containing solution, is then added. A barrier of a substance that is not permeable to liquids, such as rubber cement or IMMEDGEPEN (See also FIG. 13 using the IMMEDGEPEN), can be applied around the outside edge of the magnet or between the bottom of the magnet and the top of the slide before or after the addition of the reagent solution. FIG. 14 shows that a dye solution remained within the diameter of the magnet opening until it was allowed to dry over two days.

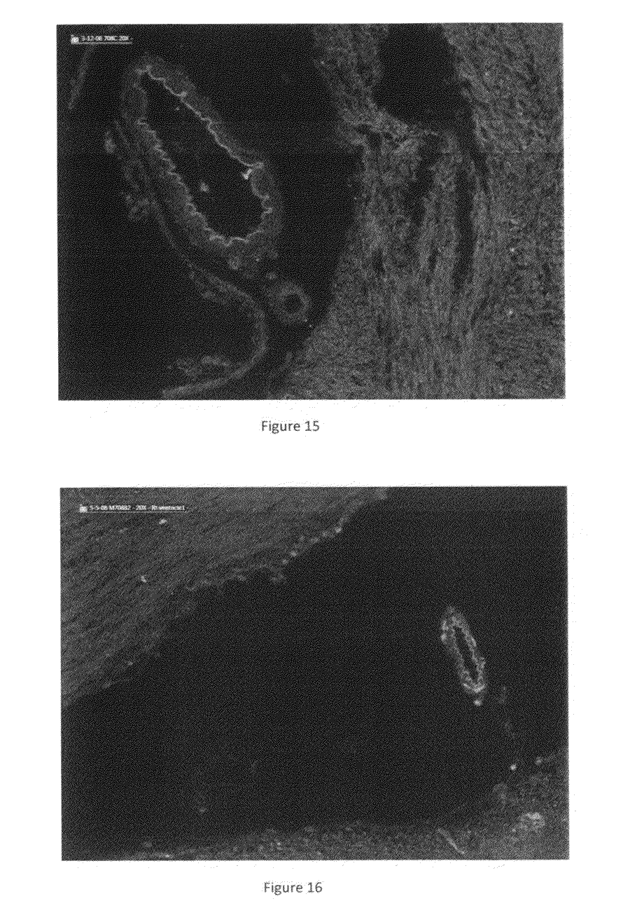

In one embodiment, the magnet used with the subject device is nickel plated. Nickel plated magnets also allow for easy cleaning and do not interfere with the antibody staining. For example, FIG. 15 shows 6E10/Hoechst-positive staining of an Alzheimer's disease mouse model's brain in the absence of using the magnetic immunohistochemistry device, and FIG. 16 shows comparable staining of the same mouse's tissue using the magnetic immunohistochemistry device. The amount and cost of the antibody solution used in FIG. 16 was about 1/14^{th} of the amount used in FIG. 15.

The subject invention also concerns methods of staining a specimen on a slide or detecting a protein or antibody in a specimen or tissue section using a device of the present invention. In one embodiment, a specimen or tissue section is placed on a slide and the slide is placed on the device. The magnet is then placed on the slide with the opening of the magnet over the specimen such that the specimen remains exposed. Alternatively, a specimen or tissue section is placed on a slide and a magnet is placed on the slide with the opening of the magnet over the specimen. The slide and magnet thereon are then placed on the device. In general, the slide is placed to be centered over the metal bracket of the device. Optionally, a barrier that is not permeable to liquids is placed around the magnet or is placed between the bottom of the magnet and the top of the slide. The specimen on the slide can be contacted with staining reagents to stain the specimen thereon, or can be contacted with reagents for detecting a protein or antibody in the specimen. In one embodiment, the reagents are subsequently removed; optionally, the specimen on the slide can be washed or treated with a suitable wash solution (e.g., phosphate buffered saline) one or more times to remove remaining reagents. After the completion of staining, the magnet can optionally be removed.

All publications, patents and patent applications mentioned in this specification are indicative of the level of skill of those skilled in the art to which this invention pertains, and are herein incorporated by reference to the same extent as if each individual publication, patent or patent application was specifically and individually indicated to be incorporated by reference.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

I claim:

1. A device comprising a free-standing metal bracket, a plastic block or foam mat adhered to a side of said metal bracket, and a magnet having an opening, wherein said device supports a slide containing a specimen of interest to be stained and said magnet surrounds the specimen of interest on the slide and said magnet is capable of retaining liquid reagent solutions within its opening to allow the specimen of interest on the slide to be contacted with the liquid reagent solution.

2. The device according to claim 1, wherein a barrier that is not permeable to liquids surrounds the outside of said magnet or surrounds the inside edge of said opening of said magnet or surrounds both.

3. The device according to claim 1, wherein said magnet has a pull force of at least about 5.25 pounds.

4. The device according to claim 1, wherein said magnet is circular and has a diameter of about 1.0″ and said opening is circular and has a diameter of about 0.5″.

5. The device according to claim 1, wherein said magnet is composed of neodymium, iron, and boron.

6. The device according to claim 1, wherein said magnet is nickel plated.

7. The device according to claim 1, wherein said plastic block or foam mat leaves about a 1 to 4 mm distance from the edge of said metal bracket.

8. The device according to claim 1, wherein said metal bracket is L-shaped or V-shaped.

9. The device according to claim 1, wherein said magnet is coated with a hydrophobic polymer.

10. The device according to claim 1, wherein said device further comprises a detachable covering or lid that fits over said opening of said magnet.

11. The device according to claim 10, wherein said covering or lid is composed of metal.

12. A method for staining a specimen on a slide using the device of claim 1, said method comprising placing a slide, with a specimen thereon, upon said device, wherein said magnet is placed upon said slide with said opening of said magnet over the specimen so that the specimen remains exposed; and contacting the specimen on said slide with a liquid reagent solution for staining the specimen.

13. The method according to claim 12, wherein the liquid reagent solution is subsequently removed and the specimen contacted with a liquid wash solution which is subsequently removed.

14. A method for detecting a protein or antibody in a specimen on a slide using the device of claim 1, said method comprising placing a slide, with a specimen thereon, upon said device, wherein said magnet is placed upon said slide with said opening of said magnet over the specimen so that the specimen remains exposed; and contacting the specimen on said slide with a liquid reagent solution capable of binding to a protein or antibody in the specimen.

15. The method according to claim 14, wherein the liquid reagent solution is subsequently removed and the specimen contacted with a liquid wash solution which is subsequently removed.
